(19) United States
(12) Patent Application Publication
(10) Pub. No.: US 2001/0025014 A1
(43) Pub. Date: Sep. 27, 2001

(54) BODY OF ANTI-FRICTION MATERIAL AND METHOD FOR PREPARING THE BODY

(76) Inventors: WOLFGANG VESPER, BONN (DE); ULRICH WISLSPERGER, BONN (DE)

Correspondence Address: LERNER AND GREENBERG, P O BOX 2480, HOLLYWOOD, FL, 330222480

(21) Appl. No.: 09/190,084

(22) Filed: Nov. 12, 1998

(30) Foreign Application Priority Data
Nov. 11, 1997 (DE) 197 49 785.3

(51) Int. Cl. F16C 1/00; D01F 1/02

(52) U.S. Cl. 508/108; 264/211

(57) ABSTRACT

A body of anti-friction material with reduced wear is formed of at least one carbon filling and a binder matrix of synthetic resin. The body of anti-friction material contains a phosphate, especially a phosphate of di- or pyrophosphoric acid, which is fixed in fine pulverized form in the binder matrix.

### BACKGROUND OF THE INVENTION

1. Field of the Invention

The invention relates to a body of anti-friction material including at least one carbon filler and a synthetic resin binder.

Bodies of anti-friction material are used wherever at least two parts of a machine or equipment come into contact under a certain contact pressure and move with respect to each other and where there is the technical objective of achieving the smallest possible frictional resistance. With such displacement, abrasion produced at the surfaces which come into contact and heat of friction produced there should be at a minimum. Examples of those applications are shut-off valves or rotary valves in pumps and compactors, sliding bearings, floating ring seals or brushes and sliders for the transfer of electrical current. Whenever adequate lubrication is ensured between the parts which move with respect to each other, the selection of suitable materials for the parts sliding against each other presents no problems. Often, however, operating conditions are such that adequate lubrication is missing over certain periods of time during the startup or running of machines, or no lubrication is used at all and the machine has to run dry.

In those cases bodies of anti-friction material are used which contain substances with intrinsic lubricating properties, such as graphite or molybdenum sulphide. However, the lubricating ability of most of those “dry lubricants” only reaches a satisfactory value when a thin film of moisture, which can be obtained, for example, from the moisture content of the surrounding atmosphere, can be built up. If that cannot be provided, such as when working in very dry air, in extremely anhydrous media, under vacuum, at great heights or at elevated temperatures, even the intrinsic lubricating action of the materials mentioned above is no longer appropriate for the requirements and further measures are required.

The prior art discloses that in those cases, porous bodies of anti-friction material can be impregnated with synthetic resins such as phenol or furan resins, polyethylene, polyesters, polyacrylate resins, perfluorinated or partly fluorinated organic polymers or even inorganic compounds such as salts or glasses. Reference is made, for example, to an article entitled “Manufactured Carbon: A Self-Lubricating Material for Mechanical Devices”, by Robert Paxton, CRC Press Inc., Florida 1979. Phosphates and boron compounds, among inorganic compounds, are preferably used. Impregnation of the anti-friction material or its precursor with the generally salt-like or oxidic substances generally takes place by using solvents or, in the presence of an appropriate heat-resistant binder matrix, by using molten materials by simply steeping or by using a vacuum/pressure process. Frequently, a thermal treatment follows the impregnation process in order to dry the impregnated substances or to convert them into a glass-like structure by firing. However, the hygroscopic characteristics of the salt-like or oxidic dry lubricants which are advantageous for action as a dry lubricant material are a disadvantage in other respects. Although on one hand, they can act as moisture reservoirs for lubrication, on the other hand they absorb so much moisture in normal moist atmospheres that they swell greatly which leads to their partial emergence from the pores of the bodies of anti-friction material, which is associated with problems on the running surface, or may induce mechanical strain in the pore system of the material. Those problems can be dealt with by filling the residual pore volume which remains after drying or firing the salt-like or oxidic substances with a synthetic resin or by impregnating the pores with a mixture of a synthetic resin and the inorganic compound. Thus, for example, German Patent No. 965 670 discloses a porous material formed of carbon which is specified for use as a self-lubricating carbon bearing. The carbon material is impregnated with an aqueous solution of boric acid or salts of boric acid and, after drying, the material is then impregnated with substances, preferably with furan resins, which form a hard, heat-resistant resin upon heating. According to another variant, the appropriate boron compound is introduced directly into the pore system during impregnation as a mixture with the synthetic resin.

According to U.S. Pat. No. 2,909,452, the pore system of porous carbon materials for contact brushes for electric motors is partly filled with a filler of sodium pyrophosphate and is then provided with a complete filler formed of a polyester resin. U.S. Pat. No. 4,119,572 discloses that, for the same purpose, carbon-graphite materials for electrical brushes are first impregnated with solutions from which polymeric phosphates, in particular phosphates of zinc and manganese, are produced in the pore system and that the phosphates incorporated in that way are then sealed in place with a film-forming resin. Zinc or aluminum phosphate impregnation with subsequent impregnation with a liquid heat-curable polymer is used in Published European Patent Application 0 471 329 A2 in order to make electrographite materials suitable for use as rotary or shut-off valves for rotary pumps and compressors or as sliding rings under extremely dry running conditions. In all of the previously mentioned processes, a porous substrate material, preferably formed entirely of carbon, is prepared and is then processed in several subsequent steps to give utilizable bodies of anti-friction material, using impregnation plus drying and/or firing and, in most cases, additional impregnation with a synthetic resin and curing of the synthetic resin. The disadvantage of those anti-friction materials is their costly method of preparation and the fact that the additives used to improve the sliding properties are located exclusively in the pores of the particular starting material or substrate material and that so-called anti- friction discontinua are present between the pores. With regard to their use as shut-off or rotary valves, there is a further disadvantage in the comparatively large tendency to fracture of those brittle ceramic parts.

Due to those disadvantages, efforts have been made to develop less brittle anti-friction materials which can be produced less expensively. That has resulted in carbon or graphite filled, synthetic resin bonded, bodies of anti-friction material which, although they are much less expensive to prepare and have considerably less tendency to fracture, have operating and wear properties which are considerably poorer than those of ceramic-like bodies of anti-friction material.

### SUMMARY OF THE INVENTION

It is accordingly an object of the invention to provide a body of anti-friction material and a method for preparing the body, which overcome the hereinafore-mentioned disadvantages of the heretofore-known products and methods of this general type, in which sliding and wear properties of synthetic resin bonded bodies of anti-friction material containing at least one carbon filler are improved and in which the improved bodies of anti-friction material can be prepared at a low cost similar to that of known bodies of anti-friction materials. With the foregoing and other objects in view there is provided, in accordance with the invention, a body of anti-friction material, comprising at least one carbon filler, a phosphate, and a synthetic resin binder having a portion up to 40 wt.

With the objects of the invention in view, there is also provided a body of anti-friction material, comprising at least o ne carbon filler; a synthetic resin binder; and a phosphate selected from the group consisting of tribasic potassium phosphate (K₃PO₄), aluminum phosphate (AlEPO₄), sodium pyrophosphate (Na₄P₂O₇), zinc pyrophosphate (Zn₂P₂O ₇), ring-shaped and chain-shaped polyphosphates and ultraphosphates.

In accordance with another feature of the invention, the phosphate is distributed uniformly over the entire material like a filler in the form of fine to very fine particles together with the other fillers formed of carbon and optionally further phosphate-free fillers which are not formed of carbon and is incorporated, like these, in the binder matrix.

With the objects of the invention in view, there is additionally provided a method for preparing a body of anti-friction material, which comprises mixing at least one filler composed of carbon and at least one metal phosphate as well as optionally a further phosphate-free filler which has an effect on the operating characteristics but is not composed of carbon, in accordance with a predetermined formulation, without the addition of a binder, until a uniform distribution of the components is achieved, then mixing the dry mixture with a synthetic resin binder and then processing the mixture obtained in this way to give a molded article.

With the objects of the invention in view, there is furthermore provided a method for preparing a body of anti-friction material, which comprises mixing at least one filler composed of carbon, at least one metal phosphate and optionally a further, phosphate-free filler which has an effect on the operating characteristics and is not composed of carbon, and a synthetic resin binder, with each other in accordance with a predetermined formulation until a uniform distribution of the components is achieved, and then processing the mixture obtained in this way in a shaping device to give a molded article.

Metal phosphates which are suitable for use according to the invention are those which are prepared in the form of a fine powder or can be produced in a finely powdered form by mechanical measures. Powders with average particle sizes d_{50%} from 200 μm down to very fine dusts may be used. The requirement for providing as uniform a distribution as possible of the anti-friction aiding phosphate in the anti-friction material may, of course, be achieved by using appropriately fine powders. Therefore, powders preferably with particle sizes in the range from d_{50%}=30 μm, d_{90%}=100 μm, and d_{50%}=5 μm, d_{90%}=15 μm and in particular d_{50%}=7 μm, d_{50%}=30 μm are used.

Water-of-crystallization-free phosphates which are thermally stable up to at least 300° C., out of the large number of salts of phosphoric acids, are suitable for direct use as substances according to the invention. These are tertiary orthophosphates such as e.g. K₃P0₄ or AlPO₄, quaternary salts of diphosphoric acid such as, for example, Na₄P₂O₇ or Mn₂P₂O₇, ring-shaped and chain-shaped polyphosphates and ultraphosphates. However, any hydrogen phosphates or phosphates which contain water of crystallization which can be converted by heating into phosphates of the previously mentioned groups of thermally stable phosphates (anhydrous orthophosphates to ultraphosphates) may also be used. According to one variant of the invention, the carbon filler may be mixed with a hydrogen phosphate or a phosphate which contains water of crystallization of this type at a temperature which is high enough for the thermally unstable phosphates to be converted into the corresponding thermally stable phosphates. For example, secondary phosphates (HPO₄) 2are converted into di- or pyrophosphates (P₂O₇)⁴⁻ with the elimination of water under these conditions.

The dry mixture which is obtained in this way can be mixed with the binder resin and any other additives after cooling, which may optionally take place with the exclusion of moisture, and the mixture can then be shaped to give anti-friction bodies. Mixtures of two or more phosphates may be used instead of one phosphate. In practice, quaternary salts of di- or pyrophosphoric acids such as, for example, Na₄P₂O₇ are preferably used and zinc pyrophosphate Zn₂P₂O₇ is used in particular. The concentration of thermally stable phosphates in the mixture formed of fillers, binder and phosphate(s) is in the range of 1 to 25 wt. %, preferably in the range of 3 to 9 wt. % and in particular in the range of 5 to 8 wt. %. The bodies of anti-friction material contain at least one of the following substances as a carbon filler: synthetically prepared graphite such as e.g. electrographite, Lonza graphite, Kish graphite, natural graphite and petroleum coke, coal-tar pitch coke or carbon black coke, with the last three substances mentioned preferably being used in graphitized form. The carbon fillers mentioned, including graphitic and non-graphitized forms, may be used separately or in mixtures. The common feature of all of these is that they are fine-grained to dusty, i.e. their maximum particle size is not more than 3 mm. However, the individual granular fractions in a formulation may differ and the specific degrees of fineness and distribution of particle sizes may be adjusted for specific purposes.

In addition to one of the previously mentioned carbon fillers or one of the carbon filler mixtures, the body may also contain fillers which are known to a person skilled in the art per se and which have an effect on the operating characteristics of the body of anti-friction material such as, for example, silicon dioxide, silicon carbide, aluminum oxide, talcum, magnesium oxide. These substances either have a certain degree of gliding quality themselves or they have a restricted abrasive effect and are used during operation of the body of anti-friction material for cleaning the running surfaces of undesired films which are formed from material abrasion of the parts running against each other, optionally by reacting with substances taken in from the surrounding atmosphere.

In the body of anti-friction material, all of the fillers, that is phosphatets), carbon fillers and fillers not composed of carbon, have their surfaces coated with a resinous binder and the resin binder also forms the matrix which fills the cavities between the granules in the body of anti-friction material to make it substantially pore-free. The maximum temperature for use of the bodies of anti-friction material according to the invention is therefore determined by the upper limiting temperature for use of the resins being used. Binders which are preferably used are synthetic resins such as, for example, phenol, furan, epoxide, polyester, cyanate-ester resins, or even thermoplastic materials with a high glass transition temperature and which optionally also have a certain sliding effect (polyimides, fluorinated polymers such as PVDF, polyphenylenesulfide). When the bodies of anti-friction material are to be used under normal operating conditions, currently phenol and/or furan resins are preferably used, due to their beneficial cost-benefit ratio. Phenol resins of the Novolak type are particularly preferred and substances which separate formaldehyde such as e.g. hexamethylene tetramine are added to those resins for curing purposes. The use of natural resins or modified natural resins as binders is possible, but synthetic resins are more adaptable to particular requirements and are therefore mainly used. The proportion of matrix or binder resin, respectively, in the body of anti-friction material is in the range from 10 to 60 wt. %, preferably in the range from 30 to 40 wt. %.

Bodies of anti-friction material according to the invention are prepared by mixing the dry components with the binder resin, preparing a granulate or powder from the mixed material which is suitable for shaping, preferably by crushing and classification, shaping by hot press molding in a stamping press or isostatic press, extruding through the use of, for example, extrusion molding, transfer molding or injection molding and optionally after-baking the molded items obtained in order to cure the binder resin completely.

There are basically two variants of the way in which to perform this general procedure.

When working in accordance with the first variant, at least one filler formed of carbon, optionally at least one filler not composed of carbon, and at least one metal phosphate are mixed with each other in accordance with a predetermined formulation, without adding a binder, until uniform distribution of the components is achieved. Then the dry mixture is mixed with the synthetic resin binder and the mixture which is obtained in this way is then processed to give a molded article using one of the modes of operation described above or below.

When working according to the second variant, at least one filler composed of carbon, optionally at least one filler not composed of carbon, and at least one metal phosphate and a binder of synthetic resin are mixed in accordance with a predetermined formulation until uniform distribution of the components is achieved and the mixture which is obtained in this way is then processed to give a molded article in accordance with a procedure described above or below, with the aid of a shaping device.

The substances specified above in the description of the composition of the body of anti-friction material are used as components for making up the mixtures, that is the fillers composed of carbon, the optionally added fillers which are not composed of carbon, the metal phosphates and the particular resinous binder, in the methods for preparing the anti-friction material in accordance with the particular formulation and adjusted to the particular requirements of the application.

When carrying out the methods, the binder resins may be added to the solid components either in powdered form or in a pasty, liquid or dissolved form or in the form of a slurry and it is then processed together with the solids. The binder resin may be mixed with the dry components either at room temperature or at a temperature which is above the melting range or the glass transition temperature of the particular resin being used or the particular resin mixture being used.

A few preferred process variants for preparing bodies of anti- friction material according to the invention are described below.

According to a first preferred variant, the dry components carbon filler, optional filler not composed of carbon, phosphate filler and binder resin in powdered form are mixed in a first process step in a mixer until uniform distribution of the components is achieved. Then the mixture is mixed in a heated mixing unit which has a high kneading effect, e.g. a roller mixer or calendar, at a temperature which is above the softening range of the binder resin, and the binder resin is thereby melted. The hot mixture is discharged in the form of a strip or a sheet and is broken up and milled after cooling. The latter may take place, for example, on a pinned disk mill or a toothed disk mill. The milling unit is advantageously controlled in such a way that a milled and sieved material with the following particle composition is obtained during crushing and subsequent sieving: 40 to 60% 1 to 2 mm, up to 30% larger than 2 mm and up to 30% larger than 600 μm to 1 mm. The fine fraction of less than or equal to 600 μm is separated during sieving and returned to the kneading process. This milled material is compressed by injection molding or transfer molding to give shaped articles. The shaped articles which are obtained in this way are then after-baked at temperatures of 160° C. to 250° C. to cross-link the binder in order to produce either bodies of anti-friction material according to the invention or precursors thereof from which bodies of anti-friction material can be prepared by mechanical processing.

The milled material obtained after the crushing step may be further crushed, in accordance with a subvariant of the method, by milling until a degree of fineness with d_{50%} approximately 40 μm is achieved, or a grain size fraction with this degree of fineness may be obtained by classification after milling. This fine grain fraction is then compressed to molded articles in a stamping press with a heatable die block or an isostatic press which is suitable for hot compression using such a temperature program in which the resin binder is first melted but then cured. Temperatures of 160 to 200° C. are preferably used in this step. If necessary, the molded articles which are obtained in this way may still have to be conditioned after removal from the mold, to achieve complete curing of the binder resin.

According to a second preferred variant, the starting substances, that is carbon filler, optional auxiliary filler not composed of carbon, phosphate and binder resin, are poured together in accordance with the formulation in a mixer, and 5 to 20 wt. %, with respect to the entirety of the components then present, of a solvent which can dissolve the resin binder, may be added. When using phenol resins, about 10 wt. % of ethanol may be used preferably for this purpose. The mixture is then mixed first of all optionally with slight heating up to achieve a sufficient homogeneity of the mixture. The liquid-accessible surfaces of all of the solid particles are then coated with a thin layer of binder resin solution. Afterwards, with further mixing and by increasing the temperature of the mixture, the solvent is evaporated until the mixture breaks up and is present as cloddy up to granular material. After discharge from the mixer, the material is classified, optionally after a crushing procedure. The granular fractions, i.e. the fractions with particle sizes of more than 0.6 mm, are processed by injection molding or transfer molding and the remaining fine fractions are processed by hot press molding to give molded articles which, in order to obtain the final bodies of anti-friction material, may have to be after-baked to completely cross-link the binder resin.

In a third preferred variant of the method, all of the mixing components, including the finely powdered binder, are dry mixed in a mixer at room temperature until the material is completely uniform. After discharge, the powder is compressed in the die block of a stamping press or in some other suitable compression device at room temperature to give a first shaped article. This first shaped article is then transferred into the heatable compression mold of a stamping press or into the mold container of a heated isostatic press and is compressed there to give a molded article at a temperature at which the binder resin is liquid. Then the molded articles which are obtained are after-baked at temperatures of 130 to 250° C. to achieve complete cross-linking of the resin binder. If the molded articles can remain in the heated compression mold during hot compression for a long enough period of time, post-after-baking may not be necessary.

Other features which are considered as characteristic for the invention are set forth in the appended claims.

Although the invention is illustrated and described herein as embodied in a body of anti-friction material and a method for preparing the body, it is nevertheless not intended to be limited to the details given, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DESCRIPTION OF THE PREFERRED EMBODIMENTS

Referring now to the embodiments of the invention in detail, it is noted that in all of the specific examples, zinc pyrophosphate, Zn₂P₂O₇, from the Chemische Fabrik Budenheim Company at 55257 Budenheim, Germany, was the added phosphate filler. It was used with a grain fineness of d_{50%}=7 μm, d_{50%}=32 μm.

### EXAMPLE 1

Initially, 58.5 parts by wt. of natural graphite with a grain size d_{50%}=20 μm, 6.5 parts by wt. of zinc pyrophosphate with a grain size d_{50%}=7 μm, d_{99%}=32 μm and, as a binder, 35 parts by wt. of a phenol Novolak/hexamethylene tetramine mixture (proportion of hexamethylene tetramine: 11 wt. %) with a particle size d_{50%}=15 μm, having a total combined weight of 15 kg, were intensively mixed in a plowshare mixer (manufactured by Lodige Co., Paderborn, Germany, Model FM 50) equipped with a chopping device. The dry material which was homogenized in this way was then compressed at room temperature in a die block of a stamping press (manufactured by Bussmann, model HPK 60) at a pressure of 20 MPa to give a molded article with the dimensions 150×200×20 mm³. After removal from the compression mold, the molded article that was prepared in this way was transferred to a mold in a hot press having external dimensions corresponding to the article and compressed there again at a temperature of 180° C. under a pressure of 20 MPa for 25 minutes. During this process the binder was melted and largely cured. After removal from the hot press, the article was transferred to an after-baking oven and after-treated there for 72 hours at 180° C., to after-cure the binder. After removing the article from the oven and cooling, shut-off valves or other anti-friction items were prepared from the article using known mechanical processing methods.

### EXAMPLE 2

Initially, 33.75 parts by wt. of graphitized carbon black coke, d_{50%}=18 μm, 33.75 parts by wt. of electrographite, d_{50%}=14 μm, 7.5 parts by wt. of zinc pyrophosphate, d_{50%}=7 μm and, as a binder 25 parts by wt. of a mixture of phenol Novolak with hexamethylene tetramine (concentration of hexamethylene tetramine: 11 wt. %), d₅₀% about 300 μm, with a total combined weight of 15 kg, were intimately mixed in a plowshare high speed mixer from the Lodige Co. as previously described in Example 1. Then the homogenized dry mixture was transferred to a heatable kneading mixer from the Werner & Pfleiderer Co. (drum capacity 8 l), 10 wt. % of ethanol was added to the mixture and the mixture was kneaded at 40° C. for 90 minutes. The mixture discharged from the mixer was then dried at room temperature in air for 12 hours and then milled on a hammer mill to a grain distribution of d_{50%}=40 μm, d_{50%}=125 μm. As already described in Example 1, the mixture that was processed in this way was then first compressed on a stamping press (Bussmann, HPK 60) to give a pre-product with the dimensions 150×200×20 mm³ and then the pre-product which was obtained in that way was compressed on a hot press for 25 minutes under a compression pressure of 20 MPa at 180° C., in order to compact the article further and to cure the binder resin. Anti-friction materials and shut-off valves were prepared from the article by mechanical processing.

### EXAMPLE 3

Initially, 29.1 parts by wt. of graphitized carbon black coke, with a graining of d_{50%}=18 μm, 29.1 parts by wt. of electrographite with a graining of d_{50%}=25 μm, 1.1 parts by wt. of magnesium oxide with a graining of d_{50%}=10 μm. 6.9 parts by wt. of zinc pyrophosphate with a graining of d_{50%}=7 μm and 33.9 parts by wt. of a mixture of Novolak/hexamethylene tetramine (concentration of hexamethylene tetramine: 11 wt. %), d₅₀%=about 300 μm, were intimately mixed in the same way as in Example 1 in a Lodige high-speed mixer at room temperature. The mixed material was then plasticized for 7 minutes on a heated roller mixer, manufactured by Berstorff GmbH, Hanover, Germany. The temperature of the material was initially 80° C. and reached 130° C. by the end of the process. In order to check for subsequent processability by injection molding, the plasticized material was then tested in a test device with a compression forging die using a cup insert in accordance with the “cup test” according to DIN 53465. The so-called cup clamping time was between 5 and 8 seconds. After cooling the rolled strip of material emerged from the mixer, it was first coarsely broken in a precrusher, for example a roller crusher, and then finely crushed on a toothed disk mill attached to the precrusher, manufactured by Condux, Germany. After sieving out the grain fraction with a size less than or equal to 0.6 mm (less than 10 wt. %) the grain size spectrum had the following values: 27 wt. %≦1 mm, 51 wt. %=1 to 2 mm and 22 wt. %≧2 mm.

In order to produce good results, the grain size spectrum should be within the following ranges: 10 to 30 wt. %≦1 mm, 40 to 60 wt. %=1 to 2 mm and 10 to 30 wt. % >2 mm. The grain fraction of less than 0.6 mm collected during milling and classification was used in the next batch during the plasticizing stage. The milled and classified material was then transferred to a homogenizer (Nauta Model) and there adjusted to a moisture content of 1.5 wt. % by adding water (determined by using Mettler's method: determining the loss in weight after 20 minutes of thermal treatment at 105° C.). The grain material which was moistened in this way was then compressed on an injection molding machine of the Arburg Allrounder type, model 270-210—500, under the following operating conditions to give crude molded products for preparing shut-off valves and anti-friction bodies:

Injection pressure 1300 bar

Mould temperature, nozzle side 169° C.

Cylinder temperature 70° C.

Bodies of anti-friction material in accordance with the previously described Examples 1 to 3 and in accordance with other formulation variants not described in detail herein were finally processed to produce shut-off valves for three different multicell compactors and tested under the conditions given in Tables 1 to 3. The compositions and particular shaping processes and the test results for the different grades of anti-friction material are given in detail in Tables 1, 2 and 3.

TABLE 1
Wear Values for shut-off valves made of synthetic resin-bonded graphite of different grades in a
multi-cell compactor from Gebrüder Becker GmbH & Co., Model T 3.40, under the following conditions:

| Atmosphere: | | | | Dry Air | | | | | | | | | |
|---|---|---|---|---|---|---|---|---|---|---|---|---|---|
| Red. Pressure on suction side: | | | | −0.6 bar | | | | | | | | | |
| Pressure on pressure side: | | | | 0.6 bar | | | | | | | | | |
| Average rotational speed: | | | | 8.9 m/s | | | | | | | | | |
| No. of shutoff valves per compactor: | | | | 7 | | | | | | | | | |
| Dimensions of valve: | | | | 95 × 53 × 4 mm | | | | | | | | | |
| | | Carbon Filler | | | | | | | | | | | |
| | Phosphate | wt. % | | | Binder | | | | | | | | |
| | Filler | | | Graphitized | Wt. % | Other | | Radial Wear | | | Crater Wear | | |
| | Zn₂P₂O₇ | Natural | Electro- | Carbon | Novolak + | Additives | | (μm/100 hrs) | | | (μm/1000 hrs) | | |
| No. | wt. % | Graphite | graphite | Black Coke | hexa | Wt. % | Shaping | Min | Max | Mean | Min | Max | Mean |
| 1 | — | 65.0 | — | — | 35.0 | | Hot | 132 | 159 | 144 | 27 | 39 | 33 |
| | | | | | | | Compression | | | | | | |
| 2 | 6.5 | 58.5 | — | — | 35.0 | | Hot | 127 | 153 | 143 | 6 | 15 | 10 |
| | | | | | | | Compression | | | | | | |
| 3 | — | — | 37.5 | 37.5 | 25.0 | | Hot | 287 | 317 | 297 | 29 | 43 | 32 |
| | | | | | | | Compression | | | | | | |
| 4 | 7.5 | — | 33.75 | 33.75 | 25.0 | | Hot | 127 | 138 | 132 | 10 | 13 | 11 |
| | | | | | | | Compression | | | | | | |
| 5 | — | 15.3 | — | 60.0 | 24.7 | | Hot | 256 | 275 | 265 | 21 | 24 | 23 |
| | | | | | | | Compression | | | | | | |
| 6 | 7.5 | 14.0 | — | 55.7 | 22.8 | | Hot | 136 | 144 | 139 | 9 | 12 | 11 |
| | | | | | | | Compression | | | | | | |
| 7 | 6.9 | — | 29.1 | 29.1 | 33.9 | 1.0 wax | Injection | 120 | 124 | 122 | 9 | 11 | 10 |
| | | | | | | | Molding | | | | | | |
| 8 | 6.9 | — | 31.1 | 31.1 | 30.0 | 0.9 wax | Injection | 102 | 107 | 105 | 8 | 10 | 9 |
| | | | | | | | Molding | | | | | | |
| 9 | 6.9 | 31.1 | — | 31.1 | 30.0 | 0.9 wax | Hot | 172 | 190 | 181 | 16 | 19 | 17 |
| | | | | | | | Compression | | | | | | |
| 10 | — | 62.0 | — | — | 35.0 | 3.0 MoS₂ | Hot | 936 | 983 | 959 | 56 | 64 | 61 |
| | | | | | | | Compression | | | | | | |

TABLE 2
Wear Values for shut-off valves made of synthetic resin-bonded graphite of different grades in a
multi-cell compactor from Gebrüder Becker GmbH & Co., Model T 3.60, under the following conditions:

| Atmosphere: | | | | Dry Air | | | | | | | | | |
|---|---|---|---|---|---|---|---|---|---|---|---|---|---|
| Red. pressure on suction side: | | | | −0.0 bar | | | | | | | | | |
| Pressure on pressure side: | | | | 0.8 bar | | | | | | | | | |
| Average rotational speed: | | | | 12 m/s | | | | | | | | | |
| No. of shut-off valves per compactor: | | | | 7 | | | | | | | | | |
| Dimensions of valves: | | | | 115 × 50 × 4 mm | | | | | | | | | |
| | | Carbon Filler | | | | | | | | | | | |
| | Phosphate | Wt. % | | | Binder | | | | | | | | |
| | Filler | | | Graphitized | Wt. % | Other | | Radial Wear | | | Crater Wear | | |
| | Zn₂P₂O₇ | Natural | Electro- | Carbon | Novolak + | Additives | Shaping | (μm/100 hrs) | | | (μm/1000 hrs) | | |
| No. | wt. % | Graphite | graphite | Black Coke | hexa | Wt. % | - | Min | Max | Mean | Min | Max | Mean |
| 1 | — | 65.0 | — | — | 35 | — | Hot | 440 | 460 | 451 | 55 | 72 | 63 |
| | | | | | | | Compression | | | | | | |
| 11 | 7.8 | 57.2 | — | — | 35 | — | Hot | 225 | 236 | 232 | 7 | 11 | 10 |
| | | | | | | | Compression | | | | | | |
| 12 | 7.5 | — | 33.75 | 33.75 | 25 | — | Injection | 265 | 276 | 270 | 5 | 9 | 7 |
| | | | | | | | Molding | | | | | | |
| 4 | 7.5 | — | 33.75 | 33.75 | 25 | — | Hot | 152 | 157 | 154 | 2 | 6 | 3 |
| | | | | | | | Compression | | | | | | |
| 9 | 6.9 | 31.1 | — | 31.1 | 30 | 0.9 wax | Hot | 120 | 143 | 127 | 8 | 10 | 9 |
| | | | | | | | Compression | | | | | | |

TABLE 3
Wear Values for shut-off valves made of synthetic resin-bonded graphite of different grades in a
multi-cell compactor from Gebrüder Becker GmbH & Co., Model T 25 DS, under the following
conditions:

| Atmosphere: | | | | Dry Air | | | | | | | | | |
|---|---|---|---|---|---|---|---|---|---|---|---|---|---|
| Red. Pressure on suction side: | | | | −0.6 bar | | | | | | | | | |
| Pressure on pressure side: | | | | 0.6 bar | | | | | | | | | |
| Average rotational speed: | | | | 8.1 m/s | | | | | | | | | |
| No. of shut-off valves per compactor: | | | | 8 | | | | | | | | | |
| Dimensions of valves: | | | | 82 × 38 × 4 mm | | | | | | | | | |
| | | Carbon Filler | | | | | | | | | | | |
| | Phosphate | Wt. % | | | Binder | | | | | | | | |
| | Filler | | | Graphitized | Wt. % | Other | | Radial Wear | | | Axial Wear | | |
| | Zn₂P₂O₇ | Natural | Electro- | Carbon | Novolak + | Additives | Shaping | (μm/100 hrs) | | | (μm/1000 hrs) | | |
| No. | wt. % | Graphite | graphite | Black Coke | hexa | Wt. % | - | Min | Max | Mean | Min | Max | Mean |
| 13 | — | 65 | — | — | 35 | — | Hot | 186 | 197 | 192 | 180 | 201 | 190 |
| | | | | | | | Compression | | | | | | |
| 14 | 6.5 | 58.5 | — | — | 35 | — | Hot | 169 | 187 | 176 | 87 | 120 | 108 |
| | | | | | | | Compression | | | | | | |
| 3 | — | — | 37.5 | 37.5 | 25 | — | Hot | 135 | 149 | 141 | 127 | 167 | 143 |
| | | | | | | | Compression | | | | | | |
| 4 | 7.5 | — | 33.75 | 33.75 | 25 | — | Hot | 126 | 143 | 137 | 71 | 86 | 79 |
| | | | | | | | Compression | | | | | | |

A comparison of the values given in Tables 1, 2 and 3 shows clearly that a content of zinc phosphate in synthetic resin bonded bodies of anti-friction material has a beneficial effect on all types of wear, radial, crater and axial. Radial wear is understood to be the loss of material which is produced during sliding of the external, radial, end surface of the shut-off valve on the internal cylindrical jacket-shaped wall of the working chamber in the compactor under the radial contact pressure of the shut-off valve against this wall. Radial wear decreases the depth of the shut-off valve. Its sealing action is not affected as long as it is sufficiently well retained in the guide located on the shaft. Crater wear is the abrasion on the compression-stressed surfaces of the shut-off valve during sliding to and fro, in the recess which holds and guides the shut-off valve on the shaft that is eccentrically mounted in the working area of the compactor. Crater wear leads to weakening of the shutoff valve due to the thickness being decreased and may lead to its breakage if it is not changed in good time. Axial wear is understood to be the wear produced when the two narrow side surfaces of the shut-off valve slide along the axially located restricting surfaces of the working chamber in the compactor. Axial wear leads to leakages between the individual cells and thus to a reduction in performance of the compactor. Whereas improvements in radial wear, apart from noticeable improvements in a few examples (Table 1, Number 2 and Table 3, Number 4) are small or lie within the range of variation, the wear values for the two other types of wear, crater wear and axial wear, as compared with the comparison examples, are reduced by at least a half. That results in considerably longer service times for the anti-friction material in operational use. The improvements are independent of the carbon filler being used, of the amount of binder being added, of other additives, of the mixing and processing procedure being used and of the shaping process being used. Surprisingly, however, the grade of a shut-off valve made for comparable purposes, with a content of 3 wt. % of molybdenum disulphide, experienced catastrophic wear behavior. With regard to the invention, this shows that it is not the addition of any substances known to be anti-friction material improvers but the choice of quite specific substances, and their quite specific application, which produces the desired result required in order to arrive at improvements according to the invention.

The addition of phosphates, however, has not only a positive effect on the wear characteristics of bodies of anti-friction material but also, at least in the case of bodies of anti-friction material with phenol resin bonding, on their temperature resistance and bending resistance at high temperature. That offers advantages not only when preparing bodies of anti-friction material but also during their use at higher temperatures. See Table 4.

TABLE 4
Bending strength of anti-friction materials as a function of temperature
and as a function of final treatment temperature after shaping:

| | Conc.of | Bending Strength at ° C. (Mpa) | | | | | | Final Treatment | |
|---|---|---|---|---|---|---|---|---|---|
| No. | Zn₂P₂O₇ (wt. %) | 20° C. | 120° C. | 140° C. | 170° C. | 200° C. | 230° C. | Temperature (° C.) | Comments |
| 1 | — | 77 | 70 | 67 | 55 | 40 | | 180 | >220° C. bubble |
| | | | | | | | | | production |
| 13 | — | 82 | 71 | 70 | 65 | 44 | 36 | 180 | >200° C. evolution of |
| | | | | | | | | | gas |
| 14 | 6.5 | 77 | 64 | 65 | 54 | 46 | 35 | 180 | No changes at 230° C. |
| 14 | 6.5 | 77 | 70 | 67 | 63 | 56 | 48 | 230 | |

As can be seen from Table 4, bodies of anti-friction material without added phosphate are not stable at temperatures above 200° C. Signs of damage are the emission of gases and the forming of bubbles. Bodies of anti-friction material which have been prepared with added phosphate and in which the binders have been completely cross-linked at temperatures of only 180° C. were thermally stable at 230° C., but had at this temperature a lower bending resistance than bodies of anti-friction material with the same formulation and the same method of preparation which had been finally treated at 230° C.

The solution according to the invention has the following advantages:

It provides bodies of anti-friction material with considerably improved wear properties for use under dry running conditions.

The bodies of anti-friction material according to the invention may be prepared by less costly methods. The shaping is possible through the use of injection molding and transfer molding.

Bodies of anti-friction material according to the invention are more thermally resistant than bodies of anti-friction material without added phosphate. They have higher resistance to bending at high temperatures.

We claim:

1. A body of anti-friction material, comprising:
at least one carbon filler, a phosphate, and a synthetic resin binder having a portion up to 40 wt %.

2. A body of anti-friction material, comprising:
at least one carbon filler;
a synthetic resin binder; and
a phosphate selected from the group consisting of tribasic potassium phosphate (K₃PO₄), aluminum phosphate (AlPO₄), sodium pyrophosphate (Na₄P₂O₇), zinc pyrophosphate (Zn₂P₂O₇), ring-shaped and chain-shaped polyphosphates and ultraphosphates.

3. The body of anti-friction material according to claim 2, including zinc pyrophosphate.

4. The body of anti-friction material according to claim 1, wherein said phosphate is distributed uniformly, as a filler, in the form of fine to very fine particles, over the entire body, and is bonded into said binder matrix together with other fillers formed at least mainly of carbon.

5. The body of anti-friction material according to claim 2, wherein said phosphate is distributed uniformly, as a filler, in the form of fine to very fine particles, over the entire body, and is bonded into said binder matrix together with other fillers formed at least mainly of carbon.

6. The body of anti-friction material according to claim 3, wherein said phosphate is distributed uniformly, as a filler, in the form of fine to very fine particles, over the entire body, and is bonded into said binder matrix together with other fillers formed at least mainly of carbon.

7. The body of anti-friction material according to claim 1, wherein said phosphate is a salt of di- or pyrophosphoric acid.

8. The body of anti-friction material according to claim 4, wherein said phosphate is a salt of di- or pyrophosphoric acid.

9. The body of anti-friction material according to claim 1, wherein said at least one carbon filler is selected from the group consisting of synthetically prepared graphite, natural graphite, petroleum coke in graphitized and non-graphitized form, coal-tar pitch coke in graphitized and non-graphitized form, and carbon black coke in graphitized and non-graphitized form.

10. The body of anti-friction material according to claim 2, wherein said at least one carbon filler is selected from the group consisting of synthetically prepared graphite, natural graphite, petroleum coke in graphitized and non-graphitized form, coal-tar pitch coke in graphitized and non-graphitized form, and carbon black coke in graphitized and non-graphitized form.

11. The body of anti-friction material according to claim 3, wherein said at least one carbon filler is selected from the group consisting of synthetically prepared graphite, natural graphite, petroleum coke in graphitized and non-graphitized form, coal-tar pitch coke in graphitized and non-graphitized form, and carbon black coke in graphitized and non-graphitized form.

12. The body of anti-friction material according to claim 4, wherein said at least one carbon filler is selected from the group consisting of synthetically prepared graphite, natural graphite, petroleum coke in graphitized and non-graphitized form, coal-tar pitch coke in graphitized and non-graphitized form, and carbon black coke in graphitized and non-graphitized form.

13. The body of anti-friction material according to claim 6, wherein said at least one carbon filler is selected from the group consisting of synthetically prepared graphite, natural graphite, petroleum coke in graphitized and non-graphitized form, coal-tar pitch coke in graphitized and non-graphitized form, and carbon black coke in graphitized and non-graphitized form.

14. The body of anti-friction material according to claim 7, wherein said at least one carbon filler is selected from the group consisting of synthetically prepared graphite, natural graphite, petroleum coke in graphitized and non-graphitized form, coal-tar pitch coke in graphitized and non-graphitized form, and carbon black coke in graphitized and non-graphitized form.

15. The body of anti-friction material according to claim 1, including at least one filler not formed of carbon selected from the group consisting of silicon dioxide, silicon carbide, aluminum oxide, talc, and magnesium oxide, in addition to said at least one carbon filler.

16. The body of anti-friction material according to claim 2, including at least one filler not formed of carbon selected from the group consisting of silicon dioxide, silicon carbide, aluminum oxide, talc, and magnesium oxide, in addition to said at least one carbon filler.

17. The body of anti-friction material according to claim 3, including at least one filler not formed of carbon selected from the group consisting of silicon dioxide, silicon carbide, aluminum oxide, talc, and magnesium oxide, in addition to said at least one carbon filler.

18. The body of anti-friction material according to claim 9, including at least one filler not formed of carbon selected from the group consisting of silicon dioxide, silicon carbide, aluminum oxide, talc, and magnesium oxide, in addition to said at least one carbon filler.

19. The body of anti-friction material according to claim 13, including at least one filler not formed of carbon selected from the group consisting of silicon dioxide, silicon carbide, aluminum oxide, talc, and magnesium oxide, in addition to said at least one carbon filler.

20. The body of anti-friction material according to claim 1, including a binder selected from the group consisting of phenol resins, furan resins, epoxide resins, polyphenylensulfide resins and cyanate-ester resins.

21. The body of anti-friction material according to claim 2, including a binder selected from the group consisting of phenol resins, furan resins, epoxide resins, polyphenylensulfide resins and cyanate-ester resins.

22. The body of anti-friction material according to claim 3, including a binder selected from the group consisting of phenol resins, furan resins, epoxide resins, polyphenylensulfide resins and cyanate-ester resins.

23. The body of anti-friction material according to claim 4, including a binder selected from the group consisting of phenol resins, furan resins, epoxide resins, polyphenylensulfide resins and cyanate-ester resins.

24. The body of anti-friction material according to claim 15, including a binder selected from the group consisting of phenol resins, furan resins, epoxide resins, polyphenylensulfide resins and cyanate-ester resins.

25. The body of anti-friction material according to claim 13, including a binder selected from the group consisting of phenol resins, furan resins, epoxide resins, polyphenylensulfide resins and cyanate-ester resins.

26. The body of anti-friction material according to claim 19, including a binder selected from the group consisting of phenol resins, furan resins, epoxide resins, polyphenylensulfide resins and cyanate-ester resins.

27. In a method for preparing a body of anti-friction material formed of at least one carbon filler and at least one synthetic resin binder, the improvement which comprises:
mixing together at least one filler formed of carbon and at least one metal phosphate in granular or powdered form in accordance with a predetermined formulation, without an addition of a binder, until uniform distribution of components is achieved;
then mixing the dry mixture with the at least one synthetic resin binder; and
then processing the resulting mixture into a molded article using a compaction process under elevated temperature.

28. The method for preparing a body of anti-friction material according to claim 27, which comprises adding a di- or pryrophosphate as a metal phosphate when mixing the components.

29. The method for preparing a body of anti-friction material according to claim 28, which comprises adding zinc pryrophosphate as a metal phosphate when mixing the components.

30. In a method for preparing a body of anti-friction material formed of at least one carbon filler and at least one synthetic resin binder, the improvement which comprises:
mixing together at least one filler formed of carbon and at least one hydrogen phosphate or phosphate containing water of crystallization in granular or powdered form, in accordance with a predetermined formulation, without an addition of a binder, at a temperature high enough for the mixed phosphates to be converted into thermally stable phosphates, until a uniform distribution of components is achieved;
then mixing the dry mixture with the at least one synthetic resin binder; and
then processing the resulting mixture into a molded article using a compaction process under elevated temperature.

31. The method for preparing a body of anti-friction material according to claim 27, which comprises adding the at least one binder in a powdered, pasty, liquid, dissolved or slurried form.

32. The method for preparing a body of anti-friction material according to claim 29, which comprises adding the at least one binder in a powdered, pasty, liquid, dissolved or slurried form.

33. The method for preparing a body of anti-friction material according to claim 27, which comprises carrying out the step of mixing the at least one binder with the dry material at a temperature above the melting range of the at least one synthetic resin used as the binder.

34. The method for preparing a body of anti-friction material according to claim 32, which comprises carrying out the step of mixing the at least one binder with the dry material at a temperature above the melting range of the at least one synthetic resin used as the binder.

35. The method for preparing a body of anti-friction material according to claim 27, which comprises crushing and classifying the mixture obtained after mixing the solid components and the at least one resin binder, before shaping.

36. The method for preparing a body of anti-friction material according to claim 34, which comprises crushing and classifying the mixture obtained after mixing the solid components and the at least one resin binder, before shaping.

37. The method for preparing a body of anti-friction material according to claim 27, which comprises processing the mixture into molded articles by hot compression at temperatures above a softening range or a glass temperature and below a decomposition temperature of the at least one synthetic resin used as the binder.

38. The method for preparing a body of anti-friction material according to claim 36, which comprises processing the mixture into molded articles by hot compression at temperatures above a softening range or a glass temperature and below a decomposition temperature of the at least one synthetic resin used as the binder.

39. The method for preparing a body of anti-friction material according to claim 35, which comprises processing the mixture into molded articles by hot compression at temperatures above a softening range or a glass temperature and below a decomposition temperature of the at least one synthetic resin used as the binder.

40. The method for preparing a body of anti-friction material according to claim 27, which comprises processing the mixture by injection molding or transfer molding into molded articles.

41. The method for preparing a body of anti-friction material according to claim 38, which comprises processing the mixture by injection molding or transfer molding into molded articles.

42. The method for preparing a body of anti-friction material according to claim 35, which comprises processing the mixture by injection molding or transfer molding into molded articles.

43. The method for preparing a body of anti-friction material according to claim 27, which comprises using at least one filler formed of carbon, at least one filler not formed of carbon and at least one phosphate as filler during preparation of the dry mixture.

44. The method for preparing a body of anti-friction material according to claim 29, which comprises using at least one filler formed of carbon, at least one filler not formed of carbon and at least one phosphate as filler during preparation of the dry mixture.

45. The method for preparing a body of anti-friction material according to claim 38, which comprises using at least one filler formed of carbon, at least one filler not formed of carbon and at least one phosphate as filler during preparation of the dry mixture.

46. The method for preparing a body of anti-friction material according to claim 30, which comprises using at least one filler formed of carbon, at least one filler not formed of carbon and at least one phosphate as filler during preparation of the dry mixture.

47. In a method for preparing a body of anti-friction material formed of at least one carbon filler and at least one synthetic resin binder, the improvement which comprises:
mixing at least one filler formed of carbon, at least one metal phosphate in granular or powdered form and the at least one binder of synthetic resin with each other according to a predetermined formulation, wherein the synthetic resin has a portion up to 40 wt %, until a uniform distribution of components is achieved; and
then processing the resulting mixture into a molded article using a shaping device at elevated temperature.

48. In a method for preparing a body of anti-friction material formed of at least one carbon filler and at least one synthetic resin binder, the improvement which comprises:
mixing at least one filler formed of carbon, at least one metal phosphate selected from the group consisting of tribasic potassium phosphate (K₃PO₄), aluminum phosphate (AlPO₄), sodium pyrophosphate (Na₄P₂O₇), zinc pyrophosphate (Zn₂P₂O₇), ring-shaped and chain-shaped polyphosphates and ultraphosphates, in granular or powdered form and the at least one binder of synthetic resin, with each other according to a predetermined formulation until a uniform distribution of components is achieved; and
then processing the resulting mixture into a molded article using a shaping device at elevated temperature.

49. The method for preparing a body of anti-friction material according to claim 48, which comprises adding zinc pryrophosphate as metal phosphate when mixing the components.

50. The method for preparing a body of anti-friction material according to claim 47, which comprises adding the binder in powdered or liquid form.

51. The method for preparing a body of anti-friction material according to claim 48, which comprises adding the binder in powdered or liquid form.

52. In a method for preparing a body of anti-friction material formed of at least one carbon filler and at least one synthetic resin binder, the improvement which comprises:
mixing at least one filler formed of carbon, at least one metal phosphate in granular or powdered form and the at least one binder of synthetic resin in pasty, dissolved or slurried form, with each other according to a predetermined formulation until a uniform distribution of components is achieved; and
then processing the resulting mixture into a molded article using a shaping device at elevated temperature.

53. In a method for preparing a body of anti-friction material formed of at least one carbon filler and at least one synthetic resin binder, the improvement which comprises:
mixing at least one filler formed of carbon, at least one metal phosphate in granular or powdered form and the at least one binder of synthetic resin, with each other according to a predetermined formulation at a temperature above a melting range of the synthetic resin used as binder, until a uniform distribution of components is achieved; and
then processing the resulting mixture into a molded article using a shaping device at elevated temperature.

54. In a method for preparing a body of anti-friction material formed of at least one carbon filler and at least one synthetic resin binder, the improvement which comprises:
mixing at least one filler formed of carbon, at least one hydrogen phosphate or phosphate containing water of crystallization in granular or powdered form and the at least one binder of synthetic resin, with each other according to a predetermined formulation at a temperature high enough for the mixed phosphates to be converted into thermally stable phosphates, until a uniform distribution of components is achieved; and
then processing the resulting mixture into a molded article using a shaping device at elevated temperature.

55. The method for preparing a body of anti-friction material according to claim 47, which comprises crushing and classifying the mixture obtained after mixing the solid components and the resin binder, before shaping.

56. The method for preparing a body of anti-friction material according to claim 48, which comprises crushing and classifying the mixture obtained after mixing the solid components and the resin binder, before shaping.

57. The method for preparing a body of anti-friction material according to claim 49, which comprises crushing and classifying the mixture obtained after mixing the solid components and the resin binder, before shaping.

58. The method for preparing a body of anti-friction material according to claim 53, which comprises crushing and classifying the mixture obtained after mixing the solid components and the resin binder, before shaping.

59. The method for preparing a body of anti-friction material according to claim 47, which comprises processing the mixture by hot compression into molded articles at temperatures above a softening range or a glass temperature and below a decomposition temperature of the synthetic resin used as binder.

60. The method for preparing a body of anti-friction material according to claim 57, which comprises processing the mixture by hot compression into molded articles at temperatures above a softening range or a glass temperature and below a decomposition temperature of the synthetic resin used as binder.

61. In a method for preparing a body of anti-friction material formed of at least one carbon filler and at least one synthetic resin binder, the improvement which comprises:
mixing at least one filler formed of carbon, at least one metal phosphate in granular or powdered form and the at least one binder of synthetic resin, with each other according to a predetermined formulation until a uniform distribution of components is achieved; and
then processing the resulting mixture by injection molding or transfer molding into molded articles at elevated temperature.

62. The method for preparing a body of anti-friction material according to claim 49, which comprises processing the mixture by injection molding or transfer molding into molded articles.

63. The method for preparing a body of anti-friction material according to claim 60, which comprises processing the mixture by injection molding or transfer molding into molded articles.

64. The method for preparing a body of anti-friction material according to claim 55, which comprises processing the mixture by injection molding or transfer molding into molded articles.

65. The method for preparing a body of anti-friction material according to claim 47, which comprises mixing at least one filler formed of carbon, at least one filler not formed of carbon, at least one phosphate and at least one binder formed of synthetic resin, as constituents of a formulation, with each other until a uniform distribution of components is achieved.

66. The method for preparing a body of anti-friction material according to claim 48, which comprises mixing at least one filler formed of carbon, at least one filler not formed of carbon, at least one phosphate and at least one binder formed of synthetic resin, as constituents of a formulation, with each other until a uniform distribution of components is achieved.

67. The method for preparing a body of anti-friction material according to claim 49, which comprises mixing at least one filler formed of carbon, at least one filler not formed of carbon, at least one phosphate and at least one binder formed of synthetic resin, as constituents of a formulation, with each other until a uniform distribution of components is achieved.

68. The method for preparing a body of anti-friction material according to claim 60, which comprises mixing at least one filler formed of carbon, at least one filler not formed of carbon, at least one phosphate and at least one binder formed of synthetic resin, as constituents of a formulation, with each other until a uniform distribution of components is achieved.

69. The method for preparing a body of anti-friction material according to claim 53, which comprises mixing at least one filler formed of carbon, at least one filler not formed of carbon, at least one phosphate and at least one binder formed of synthetic resin, as constituents of a formulation, with each other until a uniform distribution of components is achieved.

70. The method for preparing a body of anti-friction material according to claim 54, which comprises mixing at least one filler formed of carbon, at least one filler not formed of carbon, at least one phosphate and at least one binder formed of synthetic resin, as constituents of a formulation, with each other until a uniform distribution of components is achieved.

71. The method for preparing a body of anti-friction material according to claim 55, which comprises mixing at least one filler formed of carbon, at least one filler not formed of carbon, at least one phosphate and at least one binder formed of synthetic resin, as constituents of a formulation, with each other until a uniform distribution of components is achieved.
